(19) United States
(12) Patent Application Publication
(10) Pub. No.: US 2026/0073363 A1
(43) Pub. Date: Mar. 12, 2026

(54) RECYCLED RESIN MATERIAL DATA MANAGEMENT SYSTEM, RECYCLED RESIN MATERIAL DATA MANAGEMENT METHOD, PROGRAM, RECYCLED RESIN MATERIAL SALES METHOD, RECYCLED RESIN MATERIAL DATA PROVISION METHOD, WASTE RESIN MATERIAL DISCRIMINATION DEVICE, AND WASTE RESIN MATERIAL DISCRIMINATION METHOD

(71) Applicant: Hitachi, Ltd., Tokyo (JP)

(72) Inventors: Hiroki NAKATSUCHI, Tokyo (JP); Ryotaro SHIMADA, Tokyo (JP); Hiroyuki SUZUKI, Tokyo (JP); Shunsuke MORI, Tokyo (JP); Kunihito KAWAMURA, Tokyo (JP)

(21) Appl. No.: 19/106,283

(22) PCT Filed: Aug. 4, 2023
(86) PCT No.: PCT/JP2023/028522

§ 371 Date: Feb. 25, 2025

(30) Foreign Application Priority Data
Oct. 4, 2022 (JP) 2022-160287

(51) Int. Cl. G06Q 10/30

(52) U.S. Cl. CPC G06Q 10/30

(57) ABSTRACT

A data management system of a recycled resin material, comprising: an input device; a processing device; and an output device, in which the input device acquires a measurement data of a recycled resin material or a waste resin material which is a raw material of the recycled resin material, the processing device calculates a characteristic amount related to at least one of a composition and a physical property of the recycled resin material or the waste resin material based on the measurement data, predicts a remaining life based on the characteristic amount of the recycled resin material or the waste resin material, and discriminates whether a mechanical recycling or a chemical recycling is to be applied to the waste resin material, and the output device outputs at least one of the measurement data, a data of the characteristic amount, a data of the remaining life, and a result of the discrimination. As a result, it is possible to effectively utilize a low-quality waste resin material as much as possible and to ensure the quality of the recycled resin material.

### TECHNICAL FIELD

The present disclosure relates to a recycled resin material data management system, a recycled resin material data management method, a program, a recycled resin material sales method, a recycled resin material data provision method, a waste resin material discrimination device, and a waste resin material discrimination method.

### BACKGROUND ART

Demand for plastics (synthetic resins) is expected to increase in the future. On the other hand, the increase in the production of new plastics derived from petroleum, which is a depleting resource, is expected to slow down, and a distribution volume of recycled plastics (recycled resin material) is expected to increase significantly.

Patent Literature 1 discloses a resource utilization selection support system that selects whether to use a collected packaging bag for reuse or recycling after being delivered to a user in a state in which a product is stored therein, in which the packaging bag is configured so that an opening portion can be resealed, and a recycling information serving as an index for determining the reuse or the recycling of the packaging bag is given, the recycling information including the number of times of the reuse of the packaging bag or a deterioration information of the packaging bag, and selects whether to use the packaging bag for the reuse or the recycling based on the recycling information. In addition, Patent Literature 1 discloses that the deterioration information includes an information on at least one of a mechanical strength, an optical transmittance, an SEM image, and a spectra obtained by an infrared spectroscopy for the packaging bag.

Patent Literature 2 discloses an authentication method in which an information on an inflow amount of a recycled resin in a manufacturer of a resin product is acquired, an information on an outflow amount of a resin product using a recycled resin in the manufacturer or a different manufacturer is acquired, and in a case where an authentication condition based on the information on the outflow amount and the inflow amount is satisfied, an authentication is given to the resin product.

### CITATION LIST

### Patent Literatures

Patent Literature 1: Japanese Patent Application Laid-Open No. 2021-43818
Patent Literature 2: International Publication No. WO2022/092278

### SUMMARY OF INVENTION

### Problems to be Resolved by the Invention

Recycled resin materials include mechanical recycling materials and chemical recycling materials. In terms of quality, the chemical recycling materials that return to raw materials are superior, while the mechanical recycling materials are superior in terms of a carbon dioxide emission and a production cost in a recycling process. Therefore, from the viewpoint of a quality, a cost, a stable procurement, a reduction of waste quantity, etc., it is important to selectively use the mechanical recycling materials and the chemical recycling materials in an advanced resource circulation.

In order to suppress the amount of newly produced plastics (unused resin materials) and satisfy the demand for plastics, it is important to reduce the amount of a waste resin material that is removed from a recycling path and to supply a high-quality recycled material. In this case, it is a problem to discriminate which of the mechanical recycling materials and the chemical recycling materials is used.

An object of the present disclosure is to effectively utilize a low-quality waste resin material as much as possible and to ensure the quality of the recycled resin material.

### Means of Solving the Problems

A data management system of a recycled resin material according to the present disclosure includes an input device, a processing device, and an output device. The input device acquires a measurement data of a recycled resin material or a waste resin material which is a raw material of the recycled resin material. The processing device calculates a characteristic amount related to at least one of a composition and a physical property of the recycled resin material or the waste resin material based on the measurement data, predicts a remaining life based on the characteristic amount of the recycled resin material or the waste resin material, and discriminates whether a mechanical recycling or a chemical recycling is to be applied to the waste resin material. And the output device outputs at least one of the measurement data, a data of the characteristic amount, a data of the remaining life, and a result of the discrimination.

### Advantageous Effects of the Invention

According to the present disclosure, it is possible to effectively utilize a low-quality waste resin material as much as possible and to ensure the quality of the recycled resin material.

### BRIEF DESCRIPTION OF DRAWINGS

FIG. 1 is a schematic diagram showing a data management system of a recycled resin material according to the present disclosure.

FIG. 2 is a schematic diagram showing an example of an overall picture of a business model including a sale of the recycled resin material, a provision of information related to the recycled resin material, etc. according to the present disclosure.

FIG. 3 is a flowchart showing a data management method of a recycled resin material of Example 1.

FIG. 4 is a flowchart showing a selling method of a recycled resin material of Example 2.

FIG. 5 is a flowchart showing a data management method of a recycled resin material according to the present disclosure.

### DESCRIPTION OF EMBODIMENTS

The present disclosure relates to a technique for calculating a characteristic amount related to at least one of a composition and a physical property of a recycled resin material or a waste resin material based on a measurement data of a recycled resin material or a waste resin material, predicting a remaining life based on the characteristic amount of the recycled resin material or the waste resin material, and discriminating which of a mechanical recycling and a chemical recycling is to be applied to the waste resin material.

According to the present disclosure, it is possible to effectively utilize a low-quality waste resin material which has not been conventionally used and stabilize a supply of a high-quality recycled resin material.

Hereinafter, embodiments of the present disclosure will be described with reference to the drawings. Examples are illustrative for describing the present disclosure, and omissions and simplifications are made as appropriate for clarity of the description. The present disclosure can be implemented in various other forms. Unless otherwise limited, the respective constituent elements may be singular or plural.

Positions, sizes, shapes, ranges etc. of the constituent elements shown in the drawings may not represent actual positions, sizes, shapes, ranges etc. in order to facilitate understanding of the invention. Therefore, the present disclosure is not necessarily limited to the positions, sizes, shapes, ranges etc. disclosed in the drawings.

Examples of the various types of information include expressions such as “table”, “list”, “queue”, and the like, but the various types of information may be expressed in a data structure other than these. For example, various kinds of information such as “XX table”, “XX list”, and “XX queue” may be “XX information”. In describing the identification information, expressions such as “identification information”, “identifier”, “name”, “ID”, and “number” are used, but these expressions can be replaced with each other.

When there are a plurality of constituent elements having the same or similar functions, the same reference numerals may be given different subscripts and explained. In addition, in a case where it is not necessary to distinguish the plurality of constituent elements, the subscripts may be omitted for explanation.

In some Examples, a processing performed by executing a program is described. Here, a computer executes a program by a processor (e.g., a CPU, GPU), and performs a process defined by the program using a storage resource (e.g., a memory), an interface device (e.g., a communication port), and the like. Therefore, a main body of the processing performed by executing the program may be a processor. Similarly, the main body of the processing performed by executing the program may be a controller, an apparatus, a system, a computer, or a node having a processor. The main body of the processing performed by executing the program may be an arithmetic unit, and may include a dedicated circuit that performs specific processing. Here, the dedicated circuitry is, for example, FPGA (Field Programmable Gate Array), ASIC (Application Specific Integrated Circuit), CPLD (Complex Programmable Logic Device), etc.

The program may be installed in a computer from a program source. The program source may be, for example, a program distribution server or a computer-readable storage medium. When the program source is a program distribution server, the program distribution server may include a processor and a storage resource for storing the program to be distributed, and the processor of the program distribution server may distribute the program to be distributed to another computer. Further, in the Examples, two or more programs may be realized as one program, or one program may be realized as two or more programs.

0001

Examples of the terminal include a smartphone, a mobile terminal such as a tablet, and a personal computer that can be connected via a telecommunication line such as the Internet.

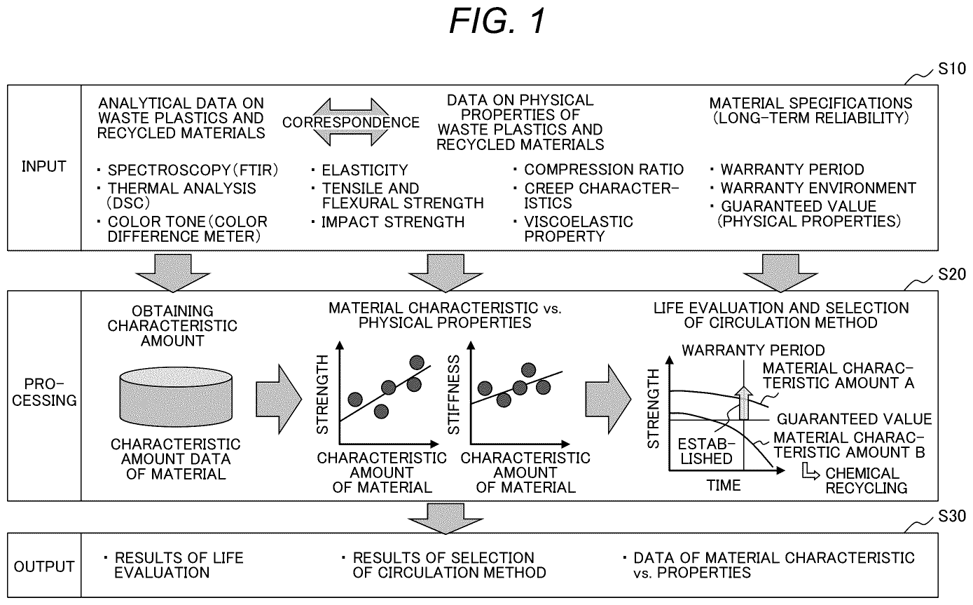

FIG. 1 is a schematic diagram illustrating a data management system of a recycled resin material according to the present disclosure. It should be noted that all of the configurations shown in the drawings may be used, but not all of them may be used, and some of them may be used.

A data management system of a recycled resin material shown in this figure includes an input device, a processing device, and an output device. Each of these devices is a component that performs an input step S10, a processing step S20, and an output step S30 in a data management method of the recycled resin materials.

In addition, the processing device may be a single processor (an arithmetic device), or may be a configuration in which two or more processors are arranged in a distributed manner. In other words, the processing step S20 may be performed by two or more processors in a division of labor. In addition, it is desirable that the data management system of the recycled resin material further includes a storage device.

In the input step S10, an analytical data of the waste resin material or the recycled resin material, a physical property data, a data of a material specification (a specification data), and the like are acquired. Here, the waste resin material is so-called waste plastics including resin members which constitutes a product discarded after use or a plastic scrap or the like generated in a manufacturing process of materials, products, parts or the like. And the recycled resin material is a resin material obtained from a waste resin material through a process of a mechanical recycling or a chemical recycling.

The analysis data includes a data such as a spectroscopic analysis (FTIR: Fourier Transform Infrared Spectroscopy), a thermal analysis (DSC: Differential Scanning Calorimetry), and a color tone (a color difference meter) of a waste resin material or a recycled resin material. The physical property data includes data such as an elastic modulus, a tensile and flexural strength, an impact strength, a compressive modulus, a creep characteristics, and a viscoelastic characteristics of the waste resin material or the recycled resin material. The specification data includes a data on a long-term reliability such as a guarantee period, a guaranteed environment, and a guaranteed value of the physical properties of the waste resin material or the recycled resin material. The analysis data and the physical property data are constituent elements of a measurement data. The specification data may also be included in the constituent elements of the measurement data.

In the processing step S20, the characteristic amount or the like is acquired or calculated from the analytical data of the waste resin material or the recycled resin material. For example, a correlation or the like between the characteristic amount and the physical property data is generated or acquired. Further, in the processing step S20, a data of a life assessment and the like are generated from changes in physical property data such as strength over time, and a recycling method (a circulation method) is selected. The recycling method includes the mechanical recycling and the chemical recycling, and also includes reuse. It is desirable to store the analysis data, the physical property data, the characteristic amount, and the like in a storage device as a database.

Here, the mechanical recycling is a method in which the collected used resin product is subjected to processes such as sorting, grinding, and washing, and is molded again. The chemical recycling is a method in which a collected used resin product is subjected to processes such as sorting, grinding, and washing, and then depolymerized to decompose and purify the collected used resin product into a raw material or an intermediate raw material of a resin, and the resulting material is polymerized to form a new resin material.

For example, when physical property data such as strength falls below the guaranteed value, or when the guaranteed period has expired, the chemical recycling is applied without applying the mechanical recycling.

In the output step S30, data such as a result of the life assessment, a selection result of the recycling methods, and the correlation between the characteristic amount and the physical properties data are output. In this case, it may be output by a method of displaying on a display unit such as a screen.

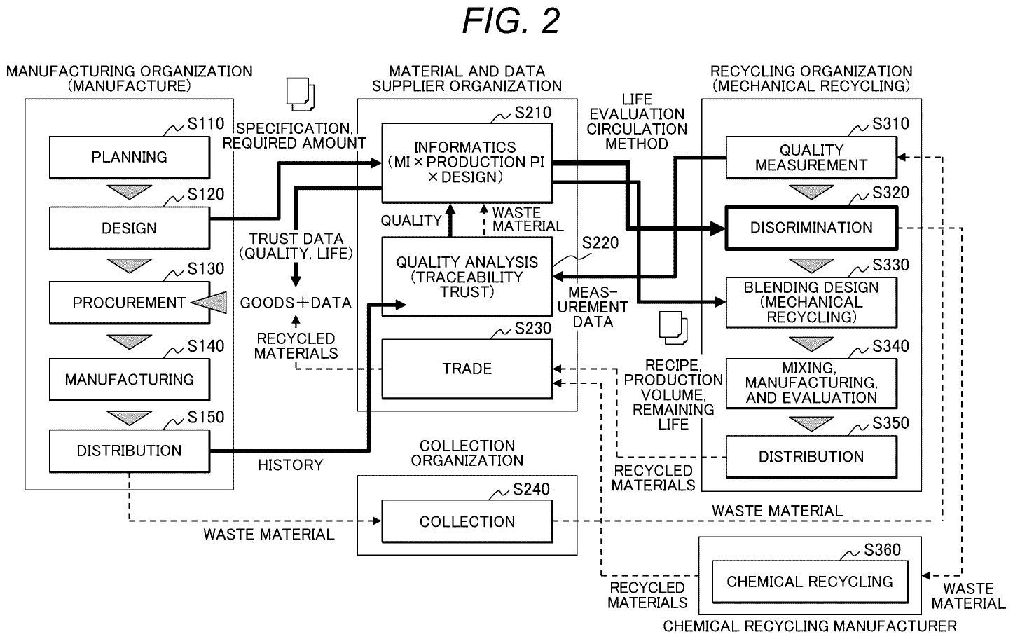

FIG. 2 is a schematic diagram showing an example of an overall picture of a business model including a sale of the recycled resin material, a provision of information related to the recycled resin material, etc. according to the present disclosure.

In this figure, a configuration in which a manufacturing organization, a material and supplier organization, a recycling organization that performs the mechanical recycling, a chemical recycling manufacturer, and a collection organization trade the waste resin materials or the recycled resin materials that are goods, and data related thereto is shown. Solid arrows represent a flow of the data and dashed arrows represent a flow of goods.

The manufacturing organizations are automobile manufacturers, home appliance manufacturers, parts manufacturers, etc., and perform a planning step S110, a design step S120, a procurement step S130, a manufacturing step S140, and a distribution step S150.

The material and supplier organization performs an informatics step S210, a quality analysis step S220, and a trade step S230.

The recycling organization performs a quality measurement step S310, a discrimination step S320, a blending design step S330, a mixing/manufacturing/evaluation step S340, and a distribution step S350.

When it is discriminated in the discrimination step S320 that the waste resin material or the recycled resin material cannot be subjected to applying the mechanical recycling based on its physical property data etc., the recycling organization transfers the waste resin material or the recycled resin material to the chemical recycling manufacturer. The chemical recycling manufacturer performs a chemical recycling step S360 to produce chemical recycled materials.

The collection organization performs a collection step S240 of collecting the waste resin material from the manufacturing organization and sending it to the recycling organization.

In the informatics step S210 of the material and supplier organization, a recipe of the resin material to be provided to the manufacturing organization is determined based on a data such as specifications and a required amount of the resin determined in the design step S120 by using a method of material informatics (MI: Materials Informatics) and manufacturing process informatics (Manufacturing PI: Manufacturing Process Informatics) and also as a condition of a design quality. Here, the resin material includes an unused resin material, a mechanical recycling material, and a chemical recycling material.

In the quality analysis step S220 of the material and supplier organization, it is possible to acquire a history of the waste resin material from the distribution step S150 of the manufacturing organization, that is, the content ratio of the unused resin material, the mechanical recycling material and the chemical recycling material, the number of times of recycling and the like, and it is possible to acquire a measurement result of the waste resin material from the quality measurement step S310 of the recycling organization, etc. The results obtained in the quality analysis step S220 are then sent to the informatics step S210.

The waste resin material is sent from the manufacturing organization to the collection organization and from the collection organization to the recycling organization. Thereafter, the measurement data of the waste resin material is measured in the quality measurement step S310, and the application of mechanical recycling or chemical recycling is discriminated in the discrimination step S320. When chemical recycling is applied, the waste resin material is sent to the chemical recycling manufacturer.

The material and supplier organization purchases a recycled resin material from the recycling organization or the chemical recycling manufacturer and sells the recycled resin material to the manufacturing organization or the like in a trade step S230. In this instance, the material and supplier organization may send a trust data such as a quality, a lifetime, the trust data obtained in the informatics step S210, along with the recycled resin material (goods) to the manufacturing organization etc.

Recipes generated in the informatics step S210, desired production quantities and remaining life, etc. may be sent to the blending design step S330 for use in the production of the mechanical recycled material.

Next, Examples will be described.

### Example 1

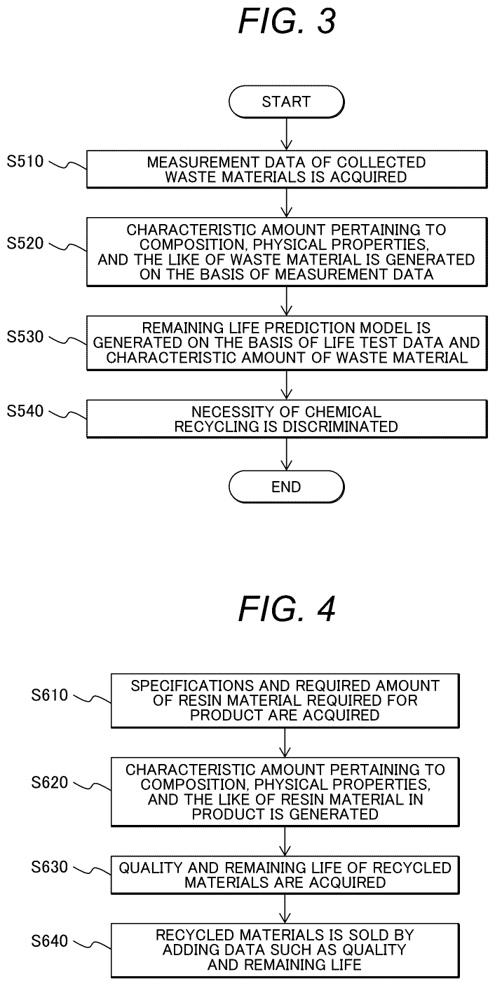

FIG. 3 is a flowchart showing a data management method of a recycled resin material of Example 1.

In this drawing, a measurement data of the collected waste resin material is acquired (step S510). Next, a characteristic amount related to the composition, the physical properties etc. of the waste resin material is generated based on the measurement data (step S520). Next, a remaining life prediction model is generated based on a life test data and the characteristic amount of the waste resin material (step S530). Then, necessity of the chemical recycling is discriminated (step S540).

### Example 2

FIG. 4 is a flowchart showing a selling method of a recycled resin material of Example 2.

In this drawing, the specification and the required amount of the resin material required for the product are obtained (step S610). Next, a characteristic amount related to the composition, the physical properties etc. of the resin material used in the product is generated (step S620). Next, the quality, the remaining life etc. of the recycled material is obtained (step S630). Then, the recycled material is sold by adding the data such as the quality and the remaining life (step S640).

Hereinafter, a data management method of a recycled resin material according to the present disclosure will be described with reference to the drawings.

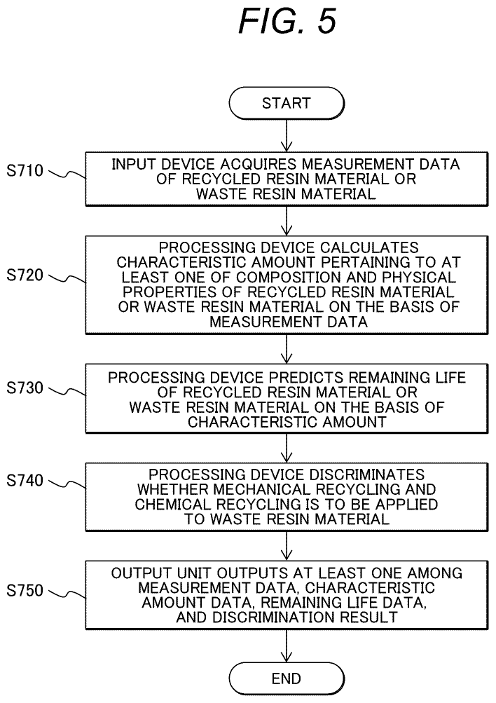

FIG. 5 is a flowchart showing a data management method of a recycled resin material according to the present disclosure.

In this drawing, the input device acquires a measurement data of the recycled resin material or the waste resin material (step S710). Next, the processing device calculates a characteristic amount related to at least one of the composition and physical properties of the resin recycle material or the waste resin material based on the measurement data (step S720). Next, the processing device predicts the remaining life based on the characteristic amount of the recycled resin material or the waste resin material (step S730). Next, the processing device discriminates which one of the mechanical recycling and the chemical recycling is to be applied to the waste resin material (step S740). Then, the output device outputs at least one of the measurement data, the data of the characteristic amount, the data of the remaining life, and the discrimination result (step S750).

In addition, the steps shown in this figure can also be applied to a selling method of the recycled resin material and a providing method of a data on the recycled resin material.

Also, the data management method of the recycled resin material, the selling method of the recycled resin material, and a providing method of a data on the recycled resin material can be executed by a computer using a program.

Hereinafter, preferred embodiments according to the present disclosure will be collectively described.

A data management system of the recycled resin material further includes a storage device, and the storage device stores the measurement data, the data of the characteristic amount, the data of the remaining life, and the data of the result of the discrimination.

The processing device generates the remaining life prediction model based on the characteristic amount of the recycled resin material or the waste resin material.

The processing device discriminates whether or not the remaining life required for the specification of the product using the recycled resin material is satisfied based on the remaining life prediction model.

The processing device applies chemical recycling to the waste resin material when the waste resin material derived from the product does not satisfy the required remaining life.

The processing device generates an information of a product that can use the recycled resin material obtained by applying the mechanical recycling to the waste resin material.

The input device acquires a usage information including at least one of a usage environment and a usage period of the product before the recycled resin material constituting the product becomes the waste resin material.

0002

The processing device generates a recipe information including at least one of a type and an amount of an additive used in manufacturing the recycled resin material using the waste resin material when the mechanical recycling is applied, based on the remaining life prediction model.

A manufacturing process of a product is generated based on a variance in the characteristic amount in a shipping lot of the recycled resin material.

In addition, the following apparatuses and methods are available for discriminating a recycling path of the waste resin material.

A discrimination device of the waste resin material calculates a characteristic amount related to at least one of a composition and a physical property of the recycled resin material or the waste resin material based on a measurement data of the recycled resin material or the waste resin material, predicts a remaining life based on the characteristic amount of the recycled resin material or the waste resin material, and discriminates which of the mechanical recycling and the chemical recycling is to be applied to the waste resin material.

A discriminating method of a waste resin material is a method that discriminates a recycle path of the waste resin material by one or more processing devices, in which a characteristic amount related to at least one of a composition and a physical property of the resin recycle material or the waste resin material is calculated based on a measurement data of the resin recycle material or the waste resin material, a remaining life is predicted based on a characteristic amount of the resin recycle material or the waste resin material, and it is discriminated which of the mechanical recycle and the chemical recycle is to be applied to the waste resin material.

### LIST OF REFERENCE SIGNS

S10: input step, S20: processing step, S30: output step.

1. A data management system of a recycled resin material, comprising: an input device; a processing device; and an output device,
wherein the input device acquires a measurement data of a recycled resin material or a waste resin material which is a raw material of the recycled resin material,
wherein the processing device
calculates a characteristic amount related to at least one of a composition and a physical property of the recycled resin material or the waste resin material based on the measurement data,
predicts a remaining life based on the characteristic amount of the recycled resin material or the waste resin material, and
discriminates whether a mechanical recycling or a chemical recycling is to be applied to the waste resin material,
and wherein the output device outputs at least one of the measurement data, a data of the characteristic amount, a data of the remaining life, and a result of the discrimination.

2. The data management system according to claim 1, further comprising a storage device,
wherein the storage device stores the measurement data, the data of the characteristic amount, the data of the remaining life, and a data of the result of the discrimination.

3. The data management system according to claim 1,
wherein the processing device generates a remaining life prediction model based on the characteristic amount of the recycled resin material or the waste resin material.

4. The data management system according to claim 3,
wherein the processing device discriminates whether or not the remaining life required for a specification of a product using the recycled resin material is satisfied based on the remaining life prediction model.

5. The data management system according to claim 4,
wherein the processing device applies the chemical recycling to the waste resin material when the waste resin material derived from the product does not satisfy the required remaining life.

6. The data management system according to claim 4,
wherein the processing device generates an information of the product that can use the recycled resin material obtained by applying the mechanical recycling to the waste resin material.

7. The data management system according to claim 1,
wherein the input device acquires a usage information including at least one of a usage environment and a usage period of the product before the recycled resin material constituting the product becomes the waste resin material.

8. The data management system according to claim 4,
wherein the processing device generates a recipe information including at least one of a type and an amount of an additive used in manufacturing the recycled resin material using the waste resin material when the mechanical recycling is applied, based on the remaining life prediction model.

9. The data management system according to claim 4,
wherein a manufacturing process of the product is generated based on a variance in the characteristic amount in a shipping lot of the recycled resin material.

10. A data management method of a recycled resin material, comprising the steps of:
acquiring a measurement data of a recycled resin material or a waste resin material which is a raw material of the recycled resin material by an input device;
calculating a characteristic amount related to at least one of a composition and a physical property of the recycled resin material or the waste resin material based on the measurement data,
predicting a remaining life based on the characteristic amount of the recycled resin material or the waste resin material, and
discriminating whether a mechanical recycling or a chemical recycling is to be applied to the waste resin material by a processing device; and
outputting at least one of the measurement data, a data of the characteristic amount, a data of the remaining life, and a result of the discrimination by an output device.

11. A program which causes a computer to execute a data management method according to claim 10.

12. A selling method of a recycled resin material, comprising the steps of:
acquiring a measurement data of a recycled resin material or a waste resin material which is a raw material of the recycled resin material by an input device of a manufacturing organization or a materials and supplier organization;
calculating a characteristic amount related to at least one of a composition and a physical property of the recycled resin material or the waste resin material based on the measurement data,
predicting a remaining life based on the characteristic amount of the recycled resin material or the waste resin material, and
discriminating whether a mechanical recycling or a chemical recycling is to be applied to the waste resin material by a processing device of the materials and supplier organization; and
outputting at least one of the measurement data, a data of the characteristic amount, a data of the remaining life, and a result of the discrimination by an output device of the manufacturing organization when the manufacturing organization, a recycling organization or a chemical recycling manufacturer sells the recycled resin material.

13. A providing method of a data on a recycled resin material, comprising the steps of:
acquiring a measurement data of a recycled resin material or a waste resin material which is a raw material of the recycled resin material by an input device of a recycling organization, a manufacturing organization or a materials and supplier organization;
calculating a characteristic amount related to at least one of a composition and a physical property of the recycled resin material or the waste resin material based on the measurement data,
predicting a remaining life based on the characteristic amount of the recycled resin material or the waste resin material, and
discriminating whether a mechanical recycling or a chemical recycling is to be applied to the waste resin material by a processing device of the materials and supplier organization; and
outputting at least one of the measurement data, a data of the characteristic amount, a data of the remaining life, and a result of the discrimination by an output device of the recycling organization when the recycling organization receives the waste resin material.

14. A discrimination device of a waste resin material which
calculates a characteristic amount related to at least one of a composition and a physical property of the recycled resin material or the waste resin material based on the measurement data,
predicts a remaining life based on the characteristic amount of the recycled resin material or the waste resin material, and
discriminates whether a mechanical recycling or a chemical recycling is to be applied to the waste resin material.

15. A discriminating method of a waste resin material, the method discriminating a recycle path of the waste resin material by one or more processing devices, comprising the steps of:
calculating a characteristic amount related to at least one of a composition and a physical property of the recycled resin material or the waste resin material based on the measurement data,
predicting a remaining life based on the characteristic amount of the recycled resin material or the waste resin material, and
discriminating whether a mechanical recycling or a chemical recycling is to be applied to the waste resin material.
